(19) United States
(12) Patent Application Publication
(10) Pub. No.: US 2006/0136877 A1
(43) Pub. Date: Jun. 22, 2006

(54) Method, system and program product for capturing a semantic level state of a program

(75) Inventors: Joseph M. Gdaniec, Cary, NC (US); James P. Hennessy, Vestal, NY (US); Michael J. Howland, Endicott, NY (US)

Correspondence Address: HOFFMAN, WARNICK & D'ALESSANDRO LLC, 75 STATE ST, 14TH FL, ALBANY, NY, 12207, US

(73) Assignee: International Business Machines Corporation, Armonk, NY (US)

(21) Appl. No.: 11/022,351

(22) Filed: Dec. 22, 2004

(51) Int. Cl. G06F 9/44

(52) U.S. Cl. 717/127

(57) ABSTRACT

The present invention provides a way to collect semantic level state information for a (running) program such as a JVM. Under the present invention, a connection is first made to the virtual machine. Thereafter, a set of Application Program Interface (API) calls are made to nodes of the program to examine the program at a semantic level. Based on the API calls, semantic level state information is captured. References from the nodes (e.g., object-type nodes) of the program are then followed to other nodes (e.g., objects) to capture additional semantic level state information. As this is occurring, the present invention keeps track of all information captured and takes measures to avoid looping and/or duplication. In addition, through the use of configuration information, the present invention can control the information that is collected, as well as a depth of references followed.

### BACKGROUND OF THE INVENTION

1. Field of the Invention

The present invention generally relates to state information capture. More specifically, the present invention relates to a method, system and program product for capturing semantic level state information for a program such as a running virtual machine (e.g., a Java Virtual Machine).

2. Related Art

As known, when a Java program is compiled, byte code is produced. The byte code can be thought of as machine code instructions for a Java Virtual Machine (Java VM). Specifically, every Java interpreter, whether it is a development tool or a Web browser that can run applets, is an implementation of the JVM. Java byte code helps make the concept of “write once, run anywhere” possible. For debugging and other purposes, it is known to record the state of a JVM by recording a snapshot of various parameters (a concept known as “dumping”). This usually occurs after some type of failure has been observed. Thereafter, a debugging tool would extract information from the snapshot. Such information generally includes, among other things, a call stack for each of the program threads, and values of local variables in each call stack entry. Unfortunately, the information returned by the debugging tool typically has a content and form that describes the C program that is the JVM. That is, the information is of the JVM performing an interpretation of Java byte code. Such a form of information is not optimal for debugging a Java program. One reason is that the person responsible for debugging the Java program may not be familiar with the content and form of the program threads and call stacks of the JVM program itself. Rather, this person is more likely to be familiar with the content and form of the program threads and call stacks of the Java program execution.

Regardless, many development projects would benefit from capturing the state of a program or system at some point in time for later analysis. This is especially important in order to adhere to “First Failure Data Capture” practices, so that a malfunction can be diagnosed later by people who are not present when it occurs. Most dumping tools capture a simple snapshot of memory for later analysis. However, if they were able to capture a “semantic level” state of a running program such as a JVM, and later use a standard debugging tool to examine it, a Java programmer's view of the process could be seen (as opposed to a C programmer's). Unfortunately, no “dumping” tool provides a way to capture such state information.

In view of the foregoing, there exists a need for a method, system and program product for capturing a semantic level state of a program.

### SUMMARY OF THE INVENTION

In general, the present invention relates to a method, system and program product for capturing a semantic level state of a program such as a virtual machine. Specifically, the present invention provides a way to collect semantic level state information for a (running) program such as a JVM. Under the present invention, a connection is first made to the program. Thereafter, a set of Application Program Interface (API) calls are made to nodes of the program to examine the program at a semantic level. Based on the API calls, semantic level state information is captured. References from the nodes (e.g., object-type nodes) of the program are then followed to other nodes (e.g., objects) to capture additional semantic level state information. In a typical embodiment, the Java Debugging Interface (JDI), an API designed for interactive debugger programs, is used to connect to the program whose state is to be captured. While the JVM is temporarily suspended, information is retrieved on the loaded Java classes, and the running Java threads. This information is saved in a “dump” file or the like. Additional information is then retrieved on the values of static fields of the loaded classes, and the call stacks of the running threads. From the call stacks, information can be retrieved about local variables. Still yet, local object references that lead to other objects are followed, which may lead in turn to further objects.

In general, the information that can be retrieved from a running JVM can be viewed as a connected graph of JDI objects, with each node in the graph representing some piece of information returned by a JDI invocation. In any event, as information capture is occurring, the present invention keeps track of all information captured and takes measures to avoid looping and/or duplication. In addition, through the use of configuration information, the present invention can control the information that is collected, as well as a depth of references followed. As indicated above, the captured information is written to a “dump” file or the like and made easily viewable.

A first aspect of the present invention provides a method for capturing a semantic level state of a program, comprising: connecting to the program; making a set of Application Program Interface (API) calls to nodes of the program to examine the program at a semantic level; capturing semantic level state information based on the API calls; following references from the nodes of the program to other nodes to capture additional semantic level state information; keeping track all information captured; and writing the semantic level state information and the additional semantic level state information to a file.

A second aspect of the present invention provides a system for capturing a semantic level state of a program, comprising: a system for connecting to the program; a system for making a set of Application Program Interface (API) calls to nodes of the program to capture semantic level state information; a system for following references from the nodes of the program to other nodes to capture additional semantic level state information; a system for keeping track all information captured; and a system for writing the semantic level state information and the additional semantic level state information to a file.

A third aspect of the present invention provides a program product stored on a recordable medium for capturing a semantic level state of a program, which when executed, comprises: program code for connecting to the program; program code for making a set of Application Program Interface (API) calls to nodes of the program to capture semantic level state information; program code for following references from the nodes of the program to other nodes to capture additional semantic level state information; program code for keeping track all information captured; and program code for writing the semantic level state information and the additional semantic level state information to a file.

A fourth aspect of the present invention provides a method for deploying an application for capturing a semantic level state of a program, comprising: deploying a computer infrastructure being operable to perform the following functions: connect to the program; make a set of Application Program Interface (API) calls to nodes of the program to examine the program at a semantic level; capture semantic level state information based on the API calls; follow references from the nodes of the program to other nodes to capture additional semantic level state information; keep track all information captured; and write the semantic level state information and the additional semantic level state information to a file.

A fifth aspect of the present invention provides computer software embodied in a propagated signal for capturing a semantic level state of a program, the computer software comprising instructions to cause a computer system to perform the following functions: connect to the program; make a set of Application Program Interface (API) calls to nodes of the program to examine the program at a semantic level; capture semantic level state information based on the API calls; follow references from the nodes of the program to other nodes to capture additional semantic level state information; keep track all information captured; and write the semantic level state information and the additional semantic level state information to a file.

Therefore, the present invention provides a method, system and program product for capturing a semantic level state of a program.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a system for capturing a semantic level state of a program according to the present invention.

FIG. 2 depicts the system of FIG. 1 in greater detail.

FIG. 3 depicts the state capture program of FIGS. 1 and 2 in greater detail.

FIG. 4 depicts a first flow diagram according to the present invention.

FIG. 5 depicts a second flow diagram according to the present invention.

FIG. 6 depicts a third flow diagram according to the present invention.

FIG. 7 depicts a fourth flow diagram according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE DRAWINGS

For convenience purposes, the Detailed Description of the Drawings will have the following sections:

I. General Description

II. Illustrative Example

I. General Description

As indicated above, the present invention relates to a method, system and program product for capturing a semantic level state of a program such as a virtual machine. Specifically, the present invention provides a way to collect semantic level state information for a (running) program such as a JVM. Under the present invention, a connection is first made to the program. Thereafter, a set of Application Program Interface (API) calls are made to nodes of the program to examine the program at a semantic level. Based on the API calls, semantic level state information is captured. References from the nodes (e.g., object-type nodes) of the program are then followed to other nodes (e.g., objects) to capture additional semantic level state information. In a typical embodiment, the Java Debugging Interface (JDI), an API designed for interactive debugger programs, is used to connect to the program whose state is to be captured. While the JVM is temporarily suspended, information is retrieved on the loaded Java classes, and the running Java threads. This information is saved in a “dump” file or the like. Additional information is then retrieved on the values of static fields of the loaded classes, and the call stacks of the running threads. From the call stacks, information can be retrieved about local variables. Still yet, local object references that lead to other objects are followed, which may lead in turn to further objects.

In general, the information that can be retrieved from a running JVM can be viewed as a connected graph of JDI objects, with each node in the graph representing some piece of information returned by a JDI invocation. In any event, as information capture is occurring, the present invention keeps track of all information captured and takes measures to avoid looping and/or duplication. In addition, through the use of configuration information, the present invention can control the information that is collected, as well as a depth of references followed. As indicated above, the captured information is written to a “dump” file or the like and made easily viewable (as will be further described below).

It should be appreciated in advance that although an illustrative embodiment of the present invention will discuss capturing semantic level state information of a virtual machine such as a JVM, the teachings herein could be used to capture semantic level state information of any type of program.

II. Illustrative Example

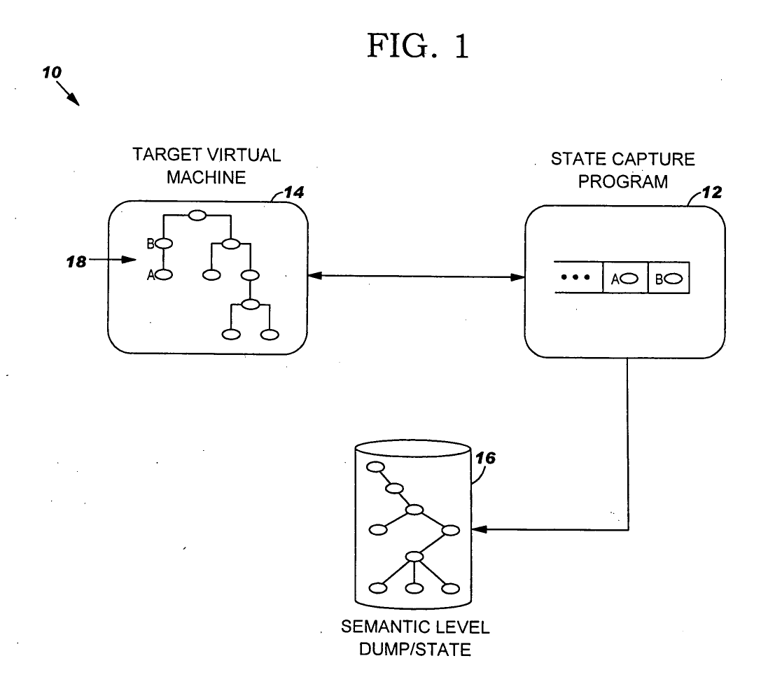

Referring now to FIG. 1, a system 10 for capturing semantic level state information according to one illustrative example of the present invention is shown. Under system 10, state capture program 12 will examine a running (target) virtual machine 14 to capture/dump semantic level state information 16. As will be further described below, the examination of virtual machine 14 includes an examination of a reference graph of nodes and/or objects 18 to retrieve information that can be later examined with any debugging tool now known or later developed such that a Java programmer's view of the process is presented (i.e., as opposed to a C programmer's view).

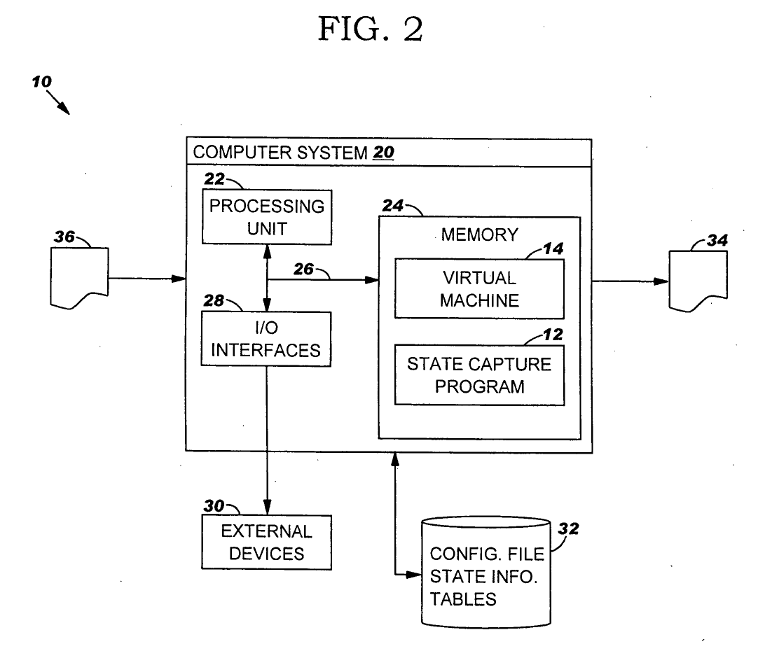

Referring to FIG. 2, system 10 is shown in greater detail. As shown, system 10 includes computer system 20, which is intended to represent any type of computer system capable of carrying out the teachings of the present invention. For example, computer system 20 could be a laptop computer, a desktop computer, a workstation, a handheld device, a client, a server, etc. Moreover, the teachings of the present invention could be implemented on a standalone computer system 20 as shown, or over a network such as the Internet, a local area network (LAN), a wide area network (WAN), a virtual private network (VPN), etc. (e.g., state capture program 12 and virtual machine 14 could be located on separate computer systems). Communication throughout the network could occur via a direct hardwired connection (e.g., serial port), or via an addressable connection that may utilize any combination of wireline and/or wireless transmission methods. Conventional network connectivity, such as Token Ring, Ethernet, WiFi or other conventional communications standards could be used. Still yet, connectivity could be provided by conventional IP-based protocol. In this instance, an Internet service provider could be used to establish interconnectivity.

As further shown, computer system 20 generally includes processing unit 22, memory 24, bus 26, input/output (I/O) interfaces 28, external devices/resources 30 and storage unit 32. Processing unit 22 may comprise a single processing unit, or be distributed across one or more processing units in one or more locations, e.g., on a client and server. Memory 24 may comprise any known type of data storage and/or transmission media, including magnetic media, optical media, random access memory (RAM), read-only memory (ROM), a data cache, a data object, etc. Moreover, similar to processing unit 22, memory 24 may reside at a single physical location, comprising one or more types of data storage, or be distributed across a plurality of physical systems in various forms.

I/O interfaces 28 may comprise any system for exchanging information to/from an external source. External devices/resources 30 may comprise any known type of external device, including speakers, a CRT, LED screen, hand-held device, keyboard, mouse, voice recognition system, speech output system, printer, monitor/display, facsimile, pager, etc. Bus 26 provides a communication link between each of the components in computer system 20 and likewise may comprise any known type of transmission link, including electrical, optical, wireless, etc.

Storage unit 32 can be any type of system (e.g., a database) capable of providing storage for information (e.g., configuration files 36, state information, type specific tables, etc.) under the present invention. As such, storage unit 32 could include one or more storage devices, such as a magnetic disk drive or an optical disk drive. In another embodiment, storage unit 32 includes data distributed across, for example, a local area network (LAN), wide area network (WAN) or a storage area network (SAN) (not shown). Although not shown, additional components, such as cache memory, communication systems, system software, etc., may be incorporated into computer system 20.

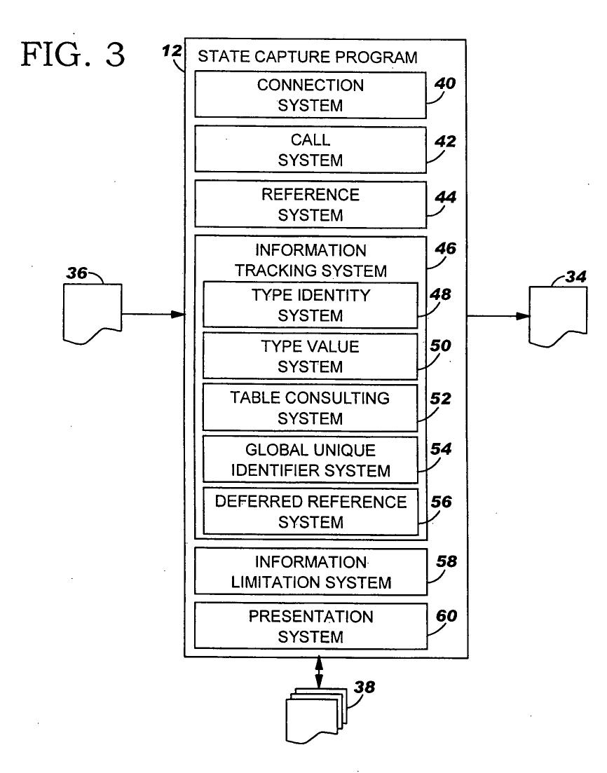

Shown in memory 24 of computer system 20 is virtual machine 14 (e.g., a JVM) and state capture program 12. Under the present invention, state capture program 12 will examine virtual machine 14 while it is running and capture a semantic level state thereof. State capture program 14 will write the state information to a file 34 or the like and make the information easily viewable. The precise functions of state capture program 12 will be explained in greater detail in conjunction with FIG. 3.

As shown in FIG. 3, state capture program 12 includes connection system 40, call system 42, reference system 44, information tracking system 46, information limitation system 58 and presentation system 60. It should be understood in advance that the depiction of state capture program 12 of FIG. 3 is intended to be illustrative only and that it could be represented by a different configuration of systems. In any event, to capture semantic level state information, connection system 40 first “connects” to virtual machine 14 (FIG. 2) using a “connector.” Once the connection has been established, call system 42 uses the connection to makes a set of Application Program Interface (API) calls to examine virtual machine 14 at the (Java) semantic level and capture semantic level state information accordingly. In general, call system 42 can “ask” about loaded Java classes, threads, the values of static fields, the values of call stack local variables, information about the states of Java monitors (e.g., locks), etc. Originally, the JDI API was created to support interactive debuggers. However, the present invention, utilizes the JDI API to capture all information that can be captured. Specifically, call system 42 can capture information on the loaded classes, on the threads that are running, and on the values of static fields of classes and local variables of every stack frame.

Once this information has been captured, reference system 44 follows the references/leads from all nodes 18 (FIG. 1) to other nodes, capturing additional semantic level state information on every node 18 and monitor as it proceeds. In a typical embodiment, the references are followed from object-types of nodes to other object-types of nodes (although this need not be limiting). Moreover, reference system 44 will follow all references to all other nodes. However, the reference depth can be limited using configuration file 36. Specifically, when a reference graph is followed, the final capture can contain a significant number of Java “objects” that are not necessarily useful in debugging a problem. The present invention can reduce the size of a dump/capture by supporting configuration information (e.g., within configuration file 36) that specifies that Java node/object references should only be followed to a fixed depth by reference system 44. A reference from a stack frame or a static class field would constitute the first reference. After that, any object that requires following the reference chain more “hops” than specified in the configuration information is omitted. Limiting the depth of the search not only results in a smaller “capture/dump” file 34, but also allows the capture to occur very quickly, so that the capture operation is not overly disruptive to the running program. This also introduces the possibility of investigating a problem by capturing a series of dumps over time. This would allow a user to look for trends that might be important in diagnosing a problem.

As further shown in FIG. 3, state capture program 12 also includes information tracking system 46, which keeps track of all information it has already observed and/or captured to prevent the process from getting into a loop or capturing duplicate information. Specifically, as depicted, information tracking system 46 includes type identity system 48, type value system 50, table consulting system 52, global unique identifier (GID) system 54 and deferred reference system 56.

One problem that arises when following a complete reference graph occurs in identifying when a certain node has already been visited, or has already been scheduled to be visited. Under the present invention, a node might represent information on a loaded class, a stack frame, a frame element, a thread, a Java object, or several dozen other possibilities, so this is non-trivial. Further, when capturing/dumping information on a certain node, it is necessary to write some sort of reference to all the nodes referenced by the node being captured/dumped. However, prior to the present invention, this was difficult because the nodes being referenced have not themselves necessarily been dumped yet.

These twin problems are solved herein by a concept called a “deferred reference.” Specifically, when a node is visited, any other nodes referenced from the node being visited must be added to a queue to be visited. During this procedure, a “node registry” is examined to determine if the referenced node has already been dumped, or if it is scheduled to be dumped. In either case, a “deferred reference” is returned to the “dumping” code processing the referencing node. The deferred reference contains all the information needed on the node being referenced when the dump is viewed.

The following is a more detailed look at this procedure. When a node is being referenced by some other node, the following algorithm is used:
1. The type (e.g., thread, etc.) of the node being referenced is determined by type identity system 48.
2. A value is created by type value system 50 that is unique among all nodes of that type. The value is determined by making a brief visit to the node just long enough to obtain some information that makes that node different than other nodes of its type. For example, if the node represents a stack frame, the information might be the thread identifier of the thread with that stack, and the depth of the stack frame in the stack. If the node represents a field of some class, the information might be the class identifier and the field identifier. The value finally produced is typically an integer whose length might vary according to the type of node.
3. A type-specific table 38 is then consulted by table consulting system 52 to see if the node has already been dumped or is scheduled to be dumped. That is, the type value is used to determine what table 38 should be consulted, and then the value derived in the last step is used to examine the table 38 to see if the node has already been scheduled or processed.
4. If no entry was found in the appropriate table 38, an entry is created and a global unique identifier (GID) is created and assigned to the node by GID system 54 (e.g., a “global identifier” or “GID”, a 32-bit integer). This GID is then stored in the table entry by GID system 54.
5. A deferred reference containing the GID is returned to the dumping code by deferred reference system 56 (e.g., call system 42 and/or reference system 44) as an identifier of the node being referenced.

In a typical embodiment, the deferred reference and the GID is produced even before the referenced node is dumped, and a subsequent reference to the same node can be identified as a duplicate reference even before the node has been dumped. The deferred reference and GID being returned cannot necessarily be used immediately to view the node being referenced, since it has not yet been dumped. However, since viewing operations take place at an entirely different time, after all nodes have been dumped, this does not raise any additional problems.

The concept of a deferred reference is also useful when the dump is being viewed. When a particular node is being examined by the interactive debugger, it is not necessary for the state capture program 12 to reconstitute the entire reference graph of the nodes involved. Instead, it can read information on just the node being examined from the capture/dump file 34. If the debugger makes an API call that requires that a reference to another node be followed, the GID in the deferred reference is used to determine where in the dump file the information is stored, and the information on that node is then read.

Under the present invention, information limitation system 58 can be provided to limit or control the amount of information that is captured by call system 42 and/or reference system 44. Specifically, in practice, the size of a JVM dump mostly depends upon the complexity of the program being dumped. There are certain features of the JDI node graph being dumped that tend to make the dump large unless steps are taken. For example, a Java String object (an instance of the java.lang.String class) contains some internal fields that most programmers debugging a problem might not care about (e.g., they generally care only what the string is). Another example is that a programmer might be using a library such as an XML parser, and if a dump is captured, they probably do not care much about the internal implementation of the parser classes which would normally be written to the dump, as well as all the Java objects that are referenced by that XML parser object.

This problem is mitigated under the present invention by the concept of a “minimal object.” A minimal object is a Java object whose JDI node references are not completely followed for dumping. In a typical implementation, java.lang.String objects are handled specially and written to the dump file in a compact fashion. Configuration parameters within configuration file 36 can be specified to control how other Java classes are handled. The configuration information contains a set of patterns. If a Java object is being processed whose class name matches one of the patterns, it is identified by information limitation system 58 as a “minimal” object and dumped in a minimal form. Specifically, no information is written on fields in the object and no information is saved on monitors held by the object (e.g., limited semantic level state information is captured). When viewing the dump, a user can see the object when they view a referencing object, but it appears to reference no objects of its own. Careful selection of the class patterns to exclude can dramatically reduce the size of the dump. This can make the difference between being able to send the dump file over the network along with problem reports or not.

Another technique for reducing the size of a dump, attempting to capture only the information necessary to debug the problem, is to limit the dump to certain threads or other nodes (e.g., by specific inclusion or exclusion). A Java program might have dozens of threads when a dump is initiated, but often a failure is isolated to one thread. For example, a thread might have ended prematurely due to an uncaught exception. Information limitation system 58 can also reduce the size of a dump by supporting configuration information within configuration file 36 so that certain threads should be omitted from the dump, or that the dump should contain only certain threads. References from variables in the stack entries of those threads are followed, but not other threads.

Restricting the dump to certain threads may be especially useful in an environment that consists of several “subsystems,” where each subsystem uses several threads, but those threads are reasonably independent of the threads of other subsystems. A failure in one thread of a subsystem may dictate that all threads associated with the failing subsystem be dumped but because interaction between subsystems is limited, there is no need to dump the threads of other subsystems. It balances the time it takes to capture a dump against the need to capture the likely cause of the failure.

Once all desired semantic level state information has been captured, it is written to capture/dump file 34 by presentation system 60. File 34 can be compressed and sent to some other location for debugging. In order to make the captured information easily viewable, presentation system 60 provides an implementation of the JDI API, allowing any debugger that understands that API to “connect” to the dump. A user can direct the interactive debugger to view any information the user needs to examine to figure out the problem, displaying all information at a Java level that makes sense to the user.

In a typical embodiment, the manner in which the present invention makes the captured information viewable is to itself implement the API that an interactive debugger program uses to examine the state of a running program. In the case of a Java program, this is the JDI. Library code is provided that implements a JDI “connector” that allows an interactive debugger to “attach” to the captured dump information and view it as if it was attached directly to the live program. Capturing the entire state of the JVM makes all information available when a person uses the debugger program to view the dump as would have been available had the person attached directly to the live program, but is much more convenient since it can be done at a later time, in a location that is more suitable for debugging (e.g., where source code for the program being debugged is available). This helps to minimize any disruption in a production environment.

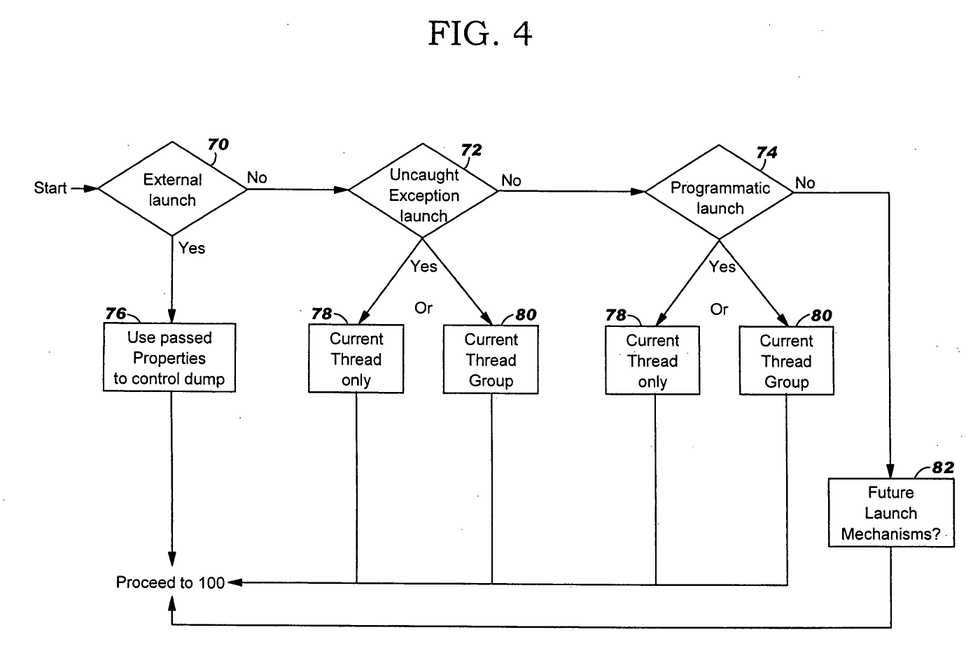

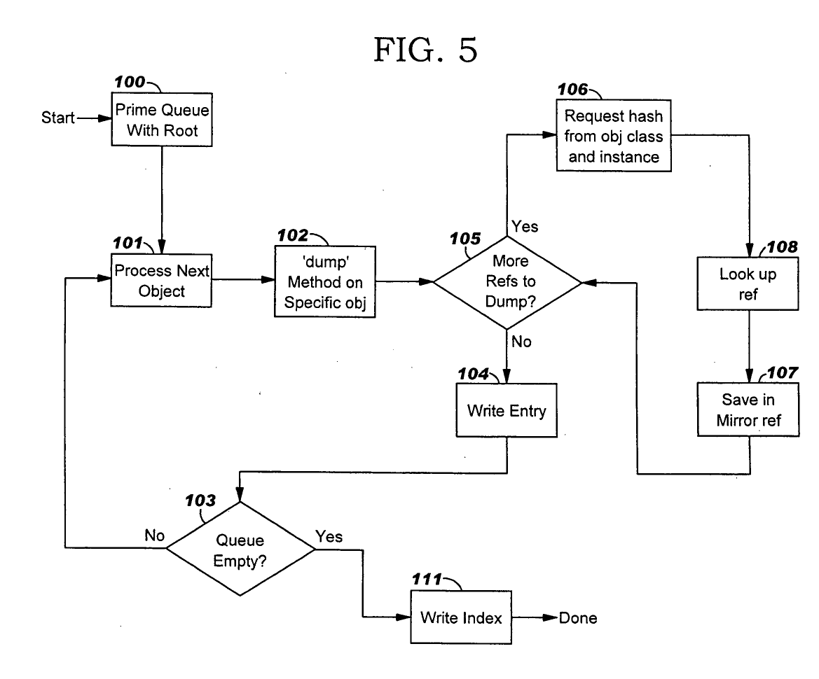

Referring now to FIGS. 4-7, a series of flow charts further describing the processes of the present invention are shown. FIG. 4 depicts a flow chart of the various ways in which the capture/dump process of the present invention can be launched. As shown, the process can be externally launched 70, launched upon an uncaught exception 72 or programmatically launched 74. If the process is externally launched in step 70, properties are used to control the dump in step 76, before the process proceeds to step 100 of FIG. 5 (to be further explained below). However, if the process is launched based on an uncaught exception in step 72 or is launched programmatically in step 74, the process can include a current thread in steps 78 or a current thread group in steps 80 before it proceeds to step 100. As further shown in FIG. 4, future launch mechanisms beyond those shown can be provided in step 82. Thus, the process of the present invention need not be limited to the launch mechanisms 70, 72 and 74 shown in FIG. 4.

Referring now to FIG. 5, the capture/dump process is shown in greater detail. In step 100, a queue is primed with a root (e.g., object). In step 101, a next object in the queue is processed, and in step 102, a dump/capture method on that object is called. In step 105, it is determined whether any more references exist to dump. If so, a hash is requested for the applicable object class and object instance in step 106. Thereafter the associated reference is looked up in step 108 and saved in a mirror reference in step 107 before it is determined whether any more references exist to dump in step 105. Once no more references to dump exist, an entry is written in step 104 before it is determined whether the queue is empty in step 103. If not, the process returns to step 101. If, however, the queue is empty in step 103, the index can be written in step 111. The writing of the index is to indicate for each GID, wherein the “dump” file that information can be retrieved.

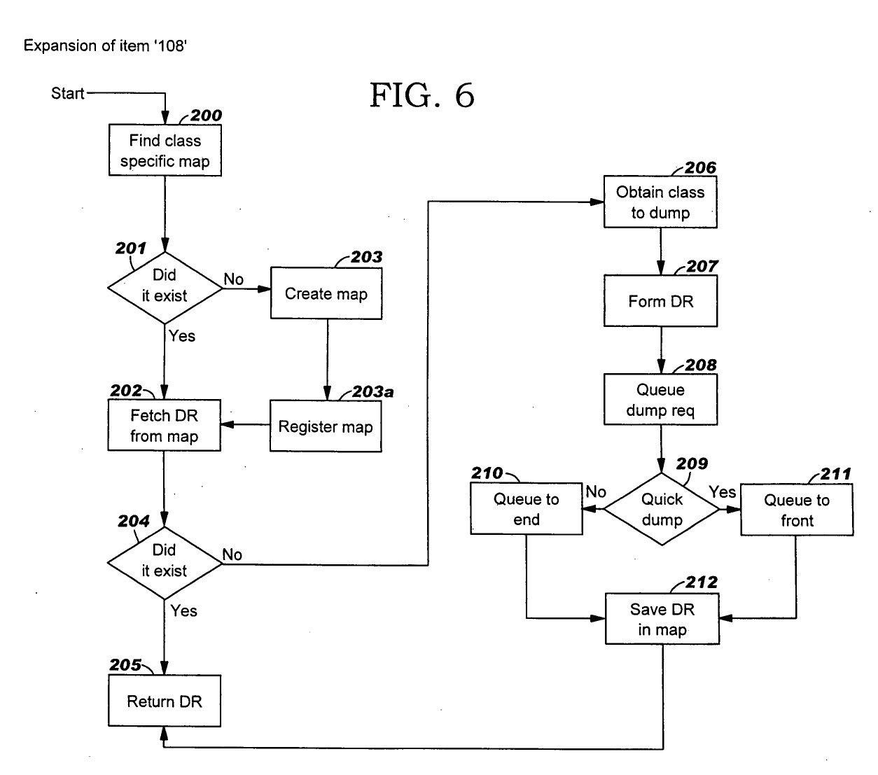

Referring now to FIG. 6, the process of looking up a reference for an object in step 108 of FIG. 5 is shown in greater detail. In step 200, a class specific map is sought. If it did not exist in step 201, it is created in step 203 and registered in step 203a. Once a map is provided, a deferred reference is retrieved from the map in step 202. If the deferred reference did not exist in step 204, a class to dump is obtained in step 206, a deferred reference is formed in step 207 and a queue dump request is generated in step 208. Thereafter, it is determined whether a quick dump is to be performed in step 209. If not, the object is queued at the end of the queue in step 210. However, if a quick dump on the object is to be performed, the object is queued at the front of the queue in step 211. Once the object is queued, the applicable deferred reference is saved in the map in step 212 and then returned in step 205.

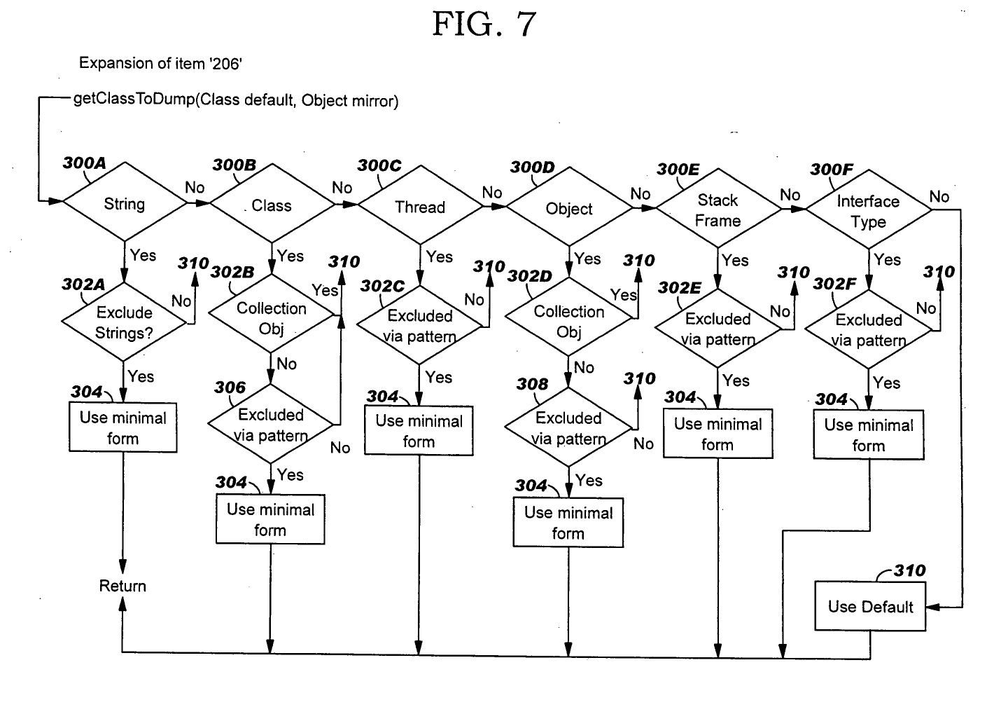

Referring now to FIG. 7, the process of obtaining a class to dump in step 206 of FIG. 6 is shown in greater detail. In steps 300A-F, a type of node to be dumped is determined (e.g., string 300A, class 300B, thread 300C, object 300D, stack frame 300E, interface type 300F). If the type is a string in step 300A, it is determined whether string should be excluded in step 302A. If so, a minimal form dump is used in step 304. If not, the default dump is used in step 310. If the type is a class in step 300B, it is determined whether it is a collection object 302B. If so, it is determined whether it should be excluded via a pattern in the configuration information in step 306. If so, the minimal form dump is used in step 304. If not, the default dump is used in step 310. If the node type is a thread in step 300C, it is determined whether it should be excluded via a pattern in step 302C. If so, the minimal form dump is used in step 304. If not, the default dump is used in step 310. If the node type is an object in step 300D, it is determined whether it is a collection object in step 302D. If so, it is then determined whether the object should be excluded via a pattern in step 308. If so, the minimal form dump is used in step 304. However, if the object is a collection object in step 302D or the object should not be excluded in step 308, the default dump is used in step 310. If the node type is a stack frame in step 300E, it will be determined whether it should be excluded via a pattern in step 302E. If so, the minimal form dump is used in step 304. If not, the default dump is used in step 310. If, in step 300F, the node type is an interface, it will be determined whether it should be excluded via a pattern in step 302F. If so, the minimal form dump is used in step 304. If not, the default dump is used in step 310.

It should be appreciated that the present invention could be offered as a business method on a subscription or fee basis. For example, computer system 20 and/or state capture program 12 could be created, supported, maintained and/or deployed by a service provider that offers the functions described herein for customers. That is, a service provider could offer to capture semantic level state information for a virtual machine for customers.

It should also be understood that the present invention could be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims. For example, state capture system 12 is shown with a certain configuration of sub-systems for illustrative purposes only. For example, the functions of call system 42 and reference system 44 could be combined within a single system.

We claim:

1. A method for capturing a semantic level state of a program, comprising:
connecting to the program;
making a set of Application Program Interface (API) calls to nodes of the program to examine the program at a semantic level;
capturing semantic level state information based on the API calls;
following references from the nodes of the program to other nodes to capture additional semantic level state information;
keeping track all information captured; and
writing the semantic level state information and the additional semantic level state information to a file.

2. The method of claim 1, wherein the program is running.

3. The method of claim 1, wherein the program is a Java Virtual Machine.

4. The method of claim 1, wherein the semantic level state information corresponds to loaded classes, static fields, call stack local variables, states of monitors, and threads, and wherein the additional semantic level state information pertains to objects of the program.

5. The method of claim 1, further comprising avoiding capturing duplicate semantic level state information for a node using the following steps:
identifying a type of the node;
creating a value that is unique for the type;
consulting a type-specific table using the value to determine if the semantic level state information on the node has already been captured or is schedule to be captured;
if no entry in the type-specific table is found for the node, creating and assigning a Global Unique Identifier (GID) to the node, and storing the GID in the type-specific table; and
returning a deferred reference that contains the GID as an identifier of the node.

6. The method of claim 1, further comprising limiting information capture using the following steps:
identifying certain nodes as minimal nodes based on configuration information;
capturing limited semantic level state information from the minimal nodes.

7. The method of claim 1, further comprising eliminating certain nodes from the method based on configuration information.

8. The method of claim 1, further comprising limiting a depth of the references followed based on configuration information.

9. A system for capturing a semantic level state of a program, comprising:
a system for connecting to the program;
a system for making a set of Application Program Interface (API) calls to nodes of the program to capture semantic level state information;
a system for following references from the nodes of the program to other nodes to capture additional semantic level state information;
a system for keeping track all information captured; and
a system for writing the semantic level state information and the additional semantic level state information to a file.

10. The system of claim 9, wherein the program is running.

11. The system of claim 9, wherein the program is a Java Virtual Machine.

12. The system of claim 9, wherein the semantic level state information corresponds to loaded classes, static fields, call stack local variables, states of monitors, and threads, and wherein the additional semantic level state information pertains to objects of the program.

13. The system of claim 9, wherein the system for keeping track of all information captured comprises:
a system for identifying a type of a node;
a system for creating a value that is unique for the type;
a system for consulting a type-specific table using the value to determine if the semantic level state information on the node has already been captured or is schedule to be captured;
a system for creating and assigning a Global Unique Identifier (GID) to the node if no entry in the type-specific table is found for the node, and for storing the GID in the type-specific table; and
a system for returning a deferred reference that contains the GID as an identifier of the node.

14. The system of claim 9, further comprising a system for limiting information capture, comprising a system for identifying certain nodes as minimal nodes based on configuration information, wherein limited semantic level state information is captured from the minimal nodes.

15. A program product stored on a recordable medium for capturing a semantic level state of a program, which when executed, comprises:
program code for connecting to the program;
program code for making a set of Application Program Interface (API) calls to nodes of the program to capture semantic level state information;
program code for following references from the nodes of the program to other nodes to capture additional semantic level state information;
program code for keeping track all information captured; and
program code for writing the semantic level state information and the additional semantic level state information to a file.

16. The program product of claim 15, wherein the program is running.

17. The program product of claim 15, wherein the program is a Java Virtual Machine.

18. The program product of claim 15, wherein the semantic level state information corresponds to loaded classes, static fields, call stack local variables, states of monitors, and threads, and wherein the additional semantic level state information pertains to objects of the program.

19. The program product of claim 15, wherein the program code for keeping track of all information captured comprises:
program code for identifying a type of the node;
program code for creating a value that is unique for the type;
program code for consulting a type-specific table using the value to determine if the semantic level state information on the node has already been captured or is schedule to be captured;
program code for creating and assigning a Global Unique Identifier (GID) to the node if no entry in the type-specific table is found for the node, and for storing the GID in the type-specific table; and
program code for returning a deferred reference that contains the GID as an identifier of the node.

20. The program product of claim 15, further comprising program code for limiting information capture, comprising program code for identifying certain nodes as minimal nodes based on configuration information, wherein limited semantic level state information is captured from the minimal nodes.

21. A method for deploying an application for capturing a semantic level state of a program, comprising:
deploying a computer infrastructure being operable to perform the following functions:
connect to the program;
make a set of Application Program Interface (API) calls to nodes of the program to examine the program at a semantic level;
capture semantic level state information based on the API calls;
follow references from the nodes of the program to other nodes to capture additional semantic level state information;
keep track all information captured; and
write the semantic level state information and the additional semantic level state information to a file.

22. Computer software embodied in a propagated signal for capturing a semantic level state of a program, the computer software comprising instructions to cause a computer system to perform the following functions:
connect to the program;
make a set of Application Program Interface (API) calls to nodes of the program to examine the program at a semantic level;
capture semantic level state information based on the API calls;
follow references from the nodes of the program to other nodes to capture additional semantic level state information;
keep track all information captured; and
write the semantic level state information and the additional semantic level state information to a file.
